(19) United States
(12) Patent Application Publication
(10) Pub. No.: US 2024/0403700 A1
(43) Pub. Date: Dec. 5, 2024

(54) MACHINE LEARNING FOR NETWORK CONTENT RECOMMENDATIONS USING EMBEDDINGS REPRESENTING DIFFERENT USER INSTANCES

(71) Applicant: Capital One Services, LLC, McLean, VA (US)

(72) Inventor: Samuel SHARPE, Cambridge, MA (US)

(73) Assignee: Capital One Services, LLC, McLean, VA (US)

(21) Appl. No.: 18/328,708

(22) Filed: Jun. 2, 2023

(51) Int. Cl. G06N 20/00

(52) U.S. Cl. CPC G06N 20/00

(57) ABSTRACT

In some embodiments, a system may predict, via a machine learning model, a set of future network actions of a user based on prior network actions of the user, where the predicted set of future network actions includes a first subset corresponding to a first version of the first user and a second subset corresponding to a second version of the user. The system may generate a first feature embedding representative of the first version of the user and a second feature embedding representative of the second version of the user. The system may determine one or more other feature embeddings that respectively satisfy a similarity threshold with the feature embeddings of the different versions of the user. Based on the other feature embeddings, the system may generate a network content recommendation for the user.

### SUMMARY

Existing systems may generate recommendations by taking a first user's embedding, finding a second user who has a similar embedding, and recommending a product that the second user liked to the first user. However, this approach may hinder the system's ability to suggest diverse products that the first user may be interested in, for example, as a result of a lack of users similar to the first user or because there are a limited number of products preferred by similar users that the first user have not already tried.

To address these and other issues, systems and methods described herein may use a machine learning model (e.g., a large language model or other machine learning model) to predict a user's future actions and then generate recommendations for the user based on the predicted actions (e.g., network content recommendations or other recommendations). As an example, the predicted actions may be used to predict different instances of the user. In some embodiments, feature embeddings may be generated based on the predicted instances of the user, and one or more feature embeddings corresponding to users similar to the predicted instances of the user may be obtained (e.g., by querying a feature embedding space or via other techniques). One or more recommendations may then be generated for the user based on the feature embeddings of those similar users (similar to the predicted instances of the user, e.g., as opposed to similar to only a representation of the user corresponding to only known actions of the user). In this way, for example, embodiments described herein may improve the diversity of recommendations and may avoid repeating the generation of the same recommendations.

In some aspects, a computing system may obtain a machine learning model that has been trained to generate probabilities of future network actions based on prior network actions of a plurality of users. The computing system may predict, via the machine learning model, a set of future network actions of a user based on prior network actions of the user, where the predicted set of future network actions includes a first subset corresponding to a first version of the first user, a second subset corresponding to a second version of the user, a third subset corresponding to a third version of the user, and so on. The computing system may generate one or more feature embeddings representing different versions of the user, such as a first feature embedding representative of the first version of the user, a second feature embedding representative of the second version of the user, a third feature embedding representative of the third version of the user, and so on. The computing system may determine one or more other feature embeddings (e.g., representative of users similar to the different versions of the user) that respectively satisfy a similarity threshold with the feature embeddings of the different versions of the user. In some embodiments, the computing system may require one or more of the other feature embeddings to satisfy the similar threshold with two or more of the feature embeddings of the different versions of the user (e.g., to decrease the risk that one of the versions of the user is not actually reflective of the user's interests). Based on the other feature embeddings, the computing system may generate one or more network content recommendations for the user.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (e.g., the entire portion), a given item (e.g., data) unless the context clearly dictates otherwise.

### BRIEF DESCRIPTION OF THE DRAWINGS

FIG. 1 shows an example diagram for a system for facilitating recommendation generation, in accordance with one or more embodiments.

FIG. 2 shows example probabilities for determining future actions of a user, in accordance with one or more embodiments.

FIG. 3 shows illustrative components for a system for facilitating recommendation generation, in accordance with one or more embodiments.

FIG. 4 shows a flowchart of the steps involved in using machine learning to generate future actions of a user to improve recommendations, in accordance with one or more embodiments.

### DETAILED DESCRIPTION OF THE DRAWINGS

In the following description, for the purposes of explanation, numerous specific details are set forth in order to provide a thorough understanding of the embodiments of the disclosure. It will be appreciated, however, by those having skill in the art that the embodiments of the disclosure may be practiced without these specific details or with an equivalent arrangement. In other cases, well-known structures and devices are shown in block diagram form in order to avoid unnecessarily obscuring the embodiments of the disclosure.

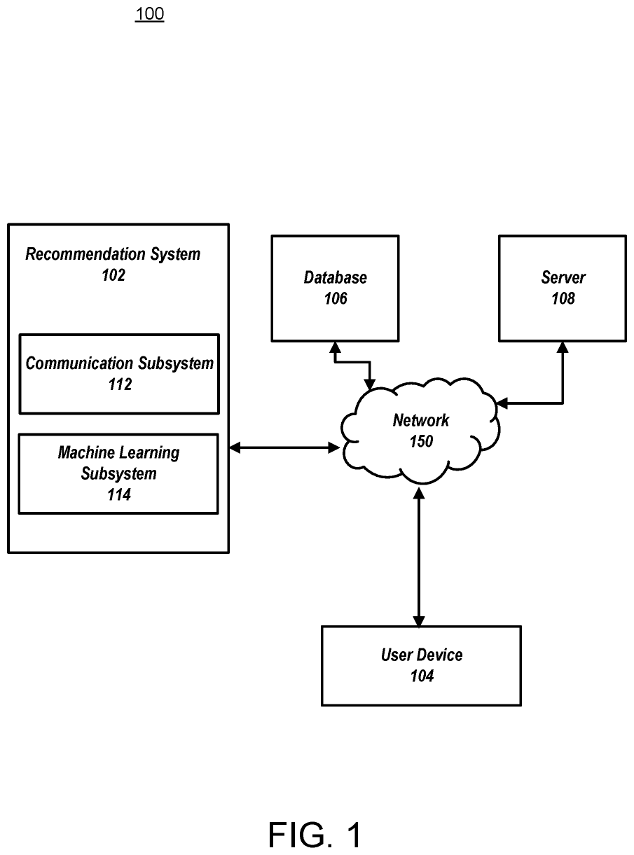

FIG. 1 shows an illustrative system 100 that may use a machine learning model to predict events related to actions of a user and generate recommendations based on the predicted events (e.g., the predicted future actions of the user). In some embodiments, system 100 may use a machine learning model to predict a user's actions and then generate recommendations for the user based on the predicted actions. As an example, the predicted actions may be used to predict different versions of the user. In some embodiments, embeddings may be generated based on the predicted versions of the user, and one or more embeddings corresponding to users similar to the predicted versions of the user may be obtained. One or more recommendations may then be generated for the user based on the embeddings of those similar users (similar to the predicted versions of the user). In this way, for example, embodiments described herein may improve the diversity of recommendations and may avoid repeating the generation of the same recommendations.

In some embodiments, the machine learning model may have been trained to generate probabilities of future actions based on prior actions of a plurality of users. System 100 may predict, via the machine learning model, a set of future actions of the user based on prior actions of the user, where the predicted set of future actions includes a first subset corresponding to a first version of the user, a second subset corresponding to a second version of the user, a third subset corresponding to a third version of the user, and so on. System 100 may generate one or more embeddings representing different versions of the user, such as a first embedding representative of the first version of the user, a second embedding representative of the second version of the user, a third embedding representative of the third version of the user, and so on. System 100 may determine one or more other embeddings (e.g., representative of users similar to the different versions of the user) that respectively satisfy a similarity threshold with the embeddings of the different versions of the user. In some embodiments, system 100 may require one or more of the other embeddings to satisfy the similar threshold with two or more of the embeddings of the different versions of the user (e.g., to decrease the risk that one of the versions of the user is not actually reflective of the user's interests). Based on the other embeddings, system 100 may generate a recommendation for the user.

The system 100 may include a recommendation system 102, a user device 104, a database 106, and a server 108 that may communicate with each other via a network 150. The recommendation system 102 may include a communication subsystem 112, a machine learning subsystem 114, or a variety of other components. In some embodiments, the system 100 may include additional devices or components such as one or more servers, firewalls, databases, or a variety of other computing devices or components.

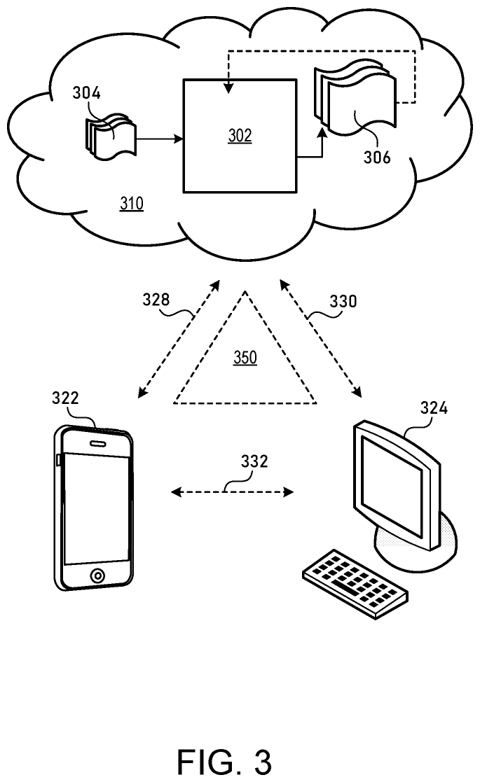

The recommendation system 102 may obtain a machine learning model. The machine learning model may be a large language model. A large language model may include a neural network with greater than a threshold number of parameters (e.g., greater than 1 billion parameters, greater than 1 trillion parameters, etc.). The large language model may have been trained using self-supervised learning. Alternatively, the machine learning model may be any model described in connection with FIG. 3. The machine learning model may have been trained to predict an event (e.g., action) or a series of events given a sequence of previous events. For example, the machine learning model may predict the next three actions a user may take (e.g., while the user is interacting with an application) given previous actions the user has taken. The machine learning model may have been trained using sequences of events (e.g., events in the order that they occurred).

The recommendation system 102 may generate a set of actions that a user is predicted to perform (e.g., network actions or other actions). As an example, an action may include any interaction a user may take with a software application (e.g., a web application, a mobile application, a desktop application, etc.). An action may include interacting (e.g., clicking, tapping, etc.) on a link. The recommendation system 102 may generate a set of predicted actions, for example, by inputting actions that the user previously performed into the machine learning model. The previous actions may be input into the machine learning model multiple times or in batches. This may enable the machine learning model to generate different sets of future actions. In some embodiments, a first portion of the previous actions may be input into the machine learning model to generate a first subset of future predicted actions, and a second portion of the previous actions may be input into the machine learning model to generate a second subset of future predicted actions. Each subset of future predicted actions may be considered a different version of the user and may be used to generate recommendations, as discussed in more detail below.

In some embodiments, the machine learning model may include a decoder of a transformer, where each action node (of a set of action nodes of the machine learning model) includes a key vector and a query vector used to generate a second action that follows a first action. The key vector may be a representation of an action or input in the model (e.g., used for matching purposes). The query vector may be another representation of an action or input in the model, but the query vector is used by the model to search for relevant information among the key vectors. For example, the query vector represents the first action and is used to find the most relevant key vectors associated with potential second actions. The model may compute the similarity between the query vector (representing the first action) and all key vectors (representing potential second actions). In one use case, the model may calculate the dot product between the query and key vectors and applying a SoftMax function to normalize the results. Based on the similarity scores, the model may generate a weighted sum of the potential second actions. As an example, in some scenarios, the higher the similarity score between a query and a key vector, the more influence that particular second action will have on the final output.

In some embodiments, the recommendation system 102 may generate one or more sets of probabilities of future actions as part of generating the set of actions. To predict a future action, the recommendation system 102 may generate a set of probabilities that includes one probability for each potential action the user could take. The recommendation system 102 may then select the action that has the highest probability as the future action. For example, a first vector in the set of probabilities may include probabilities for every possible action at a first time step, and a second vector in the set of probabilities may include probabilities for every possible action at a second time step.

In some embodiments, the recommendation system 102 may use a decoder language model to predict a set of actions that a user is predicted to perform. As an example, the decoder language model may be used to predict the next action of the user based on the previous actions of the user. In one use case, a collection of user actions of a plurality of users may be used to train the decoder language model. The user actions may be converted into a sequence of tokens, the tokens are transformed into embeddings, and the embeddings are input as training data into the decoder language model. In a further use case, the training data may be arranged as input-output pairs, where the input consists of a sequence of actions, and the output is the next action in the sequence. For example, if the original sequence of actions is [A, B, C, D], the input-output pairs may include ([A, B], C), ([A, B, C], D), and so on. The model may be trained by feeding the model the input-output pairs, where the model learns to generate the next action in the sequence by minimizing the difference (loss) between its predictions and the actual next actions in the training data. As an example, once the model is trained, the model can be used to predict the next action in a given sequence of user actions. For example, by inputting the sequence of actions into the model, the model may generate a probability distribution over all possible next actions. In one use case, the action with the highest probability may be selected as the most likely next action. In another user case, an action may be selected as the next action via a random selection (e.g., a pseudorandom selection). As an example, the action may be action via a random selection proportional to the probabilities of the possible next actions (e.g., via a pseudorandom algorithm or other randomization technique). As such, instead of simply picking the action with the highest probability (a deterministic approach), the selection involves choosing the action randomly in a way that is proportional to its probability (e.g., by sampling from the probability distribution). Although events with higher probabilities are more likely to be selected, there is still a chance that actions with lower probabilities will be selected, thereby introducing randomness into the prediction process and making the generated sequences more diverse and less deterministic.

In some embodiments, with regard to a set of actions predicted for a user, a subset of actions (e.g., corresponding to a version of the user) may be predicted by, iteratively, (i) predicting an action (e.g., a future action of the user) based on an action set (that includes prior actions of the user) and (ii) appending the predicted action to the action set, so that the subsequent action may be predicted based on the appended action set. As an example, with respect to a first subset of actions (e.g., corresponding to a first version of the user), the recommendation system 102 may (i) input a first sequential action set (e.g., including one or more of the prior actions of the user) into a machine learning model to predict a first future action of the user, (ii) append the first future action of the user to the first sequential action set such that the first future action follows the prior actions of the user in the first sequential action set, (iii) subsequent to the appending of the first future action of the user, input the first sequential action set to the machine learning model to predict a second future action of the user, (iv) append the second future action of the user to the first sequential action set such that the second future action follows the first future action of the user in the first sequential action set, and (v) so on. As such, the first sequential action set may include the first and second future actions predicted for the user. In one use case, the first subset of actions (e.g., corresponding to the first version of the user) may include the first sequential action set. In a further use case, the first sequential action set may be generated such that the second future action follows the first future action based on the prediction of the second future action being derived from the prediction of the first future action.

As another example, with respect to a second subset of actions (e.g., corresponding to a second version of the user), the recommendation system 102 may (i) input a second sequential action set (e.g., including one or more of the prior actions of the user) into the machine learning model to predict a third future action of the user, (ii) append the third future action of the user to the second sequential action set such that the third future action follows the prior actions of the user in the second sequential action set; (iii) subsequent to the appending of the third future action of the user, inputting the second sequential action set to the machine learning model to predict a fourth future action of the user, (iv) append the fourth future action of the user to the second sequential action set such that the fourth future action follows the third future action of the user in the second sequential action set, and (v) so on.

As indicated, in some embodiments, the predicted future actions may be randomly selected from a collection of candidate actions (e.g., possible actions in a probability distribution) a random selection proportional to the probabilities of the candidate actions. As an example, given the history of events or actions that have already occurred (e.g., the prior actions of the user), the model may output the probability of each possible event (e.g., the candidate actions) occurring next. After estimating the probabilities of each possible event, the recommendation system 102 may select an event based on these probabilities. As such, instead of simply picking the action with the highest probability (a deterministic approach), the selection involves choosing the action randomly in a way that is proportional to its probability (e.g., by sampling from the probability distribution via a different random seed for each selection). Although events with higher probabilities are more likely to be selected, there is still a chance that actions with lower probabilities will be selected, thereby introducing randomness into the prediction process and making the generated sequences more diverse and less deterministic. The recommendation system 102 subsequently appends the randomly-selected action to the prior actions to form an updated input and provides the updated input to the model to estimate the probabilities for the next set of candidate actions.

In some embodiments, the recommendation system 102 may delete or remove versions of a user that fail to satisfy a quality threshold. For example, a version of the user that includes negative actions may be removed or deleted so that no recommendations are generated based on the negative actions. A negative action may include a user charging off (e.g., cancelling of credit card debt due to the user's inability to pay), a user becoming late in payments, a user undergoing bankruptcy, a user committing fraud, a user being involved in a cybersecurity incident, or a variety of other actions. In one example, the recommendation system 102 may generate a set of versions of the user, where each version of the set of versions corresponds to a different set of actions generated via the machine learning model. The recommendation system 102 may determine, based on the set of versions, a third version that fails to satisfy a quality threshold. Based on the third version failing to satisfy the quality threshold, the recommendation system 102 may remove the third version from the set of versions. Subsequent to the removal, the recommendation system 102 may generate one or more recommendations based on the set of versions of the user.

In some embodiments, the recommendation system 102 may generate one or more embeddings based on one or more sets of actions of a user. An embedding may be a vector representation of one or more actions (e.g., a set of actions). Two embeddings may be close in distance, for example, if they are generated based on similar sets of actions. As an example, a first embedding may be generated by concatenating the previous actions (e.g., all of the previous actions or a portion of the previous actions) with the first subset of future predicted actions and inputting the concatenation into a machine learning model or other embedding model. In one use case, the concatenation may include a first sequential action set in which the first subset of future predicted actions follows the previous actions. The machine learning model used to generate the first embedding may be different from the machine learning model used to generate the set of future actions or they may be the same machine learning model. A second embedding may be generated by concatenating the previous actions with the second subset of future predicted actions and inputting the concatenation into a machine learning model or other embedding model (e.g., in the same manner that the first embedding was generated). In some embodiments, the recommendation system 102 may generate additional embeddings. For example, the recommendation system 102 may generate an embedding for each subset of future predicted actions. Each embedding may represent a different version of the user.

In one scenario, the recommendation system 102 may identify another embedding that satisfies a similarity threshold with the first or second embedding. The other embedding may be a representation of another user (e.g., different from the user and the different versions of the user). If the other embedding and the first or second embedding are similar, the recommendation system 102 may be able to recommend items (e.g., banking products or other products) used by the other user to the user. As an example, the similarity threshold may be associated with a distance score related to a distance between the third embedding and the first embedding or a distance score related to a distance between the third embedding and the second embedding. The recommendation system 102 may determine a distance score (e.g., cosine distance, Euclidean distance, Manhattan distance, etc.) for a pair of embeddings and compare the distance score with a distance threshold (e.g., the similarity threshold) to determine whether two embeddings are similar.

In some embodiments, the recommendation system 102 may identify one or more other embeddings that satisfy a similarity threshold respectively with the first and second embedding (e.g., similar to one embedding, but not to the other embedding). For example, the recommendation system 102 may identify a third embedding (e.g., representing a second user) that satisfies the similarity threshold with the first embedding and a fourth embedding (e.g., representing a third user) that satisfies the similarity threshold with the second embedding.

In some embodiments, the recommendation system 102 may generate one or more recommendations for a user (e.g., network content recommendations or other recommendations) based on the other embeddings (e.g., that are representative of other users) that are similar to one or more embeddings derived from predicted actions of the user (e.g., the embeddings that are representative of different versions of the user). In one use case, with respect to a third embedding (e.g., representing a second user) that satisfies the similarity threshold with a first embedding (e.g., derived from a first subset of predicted actions of the user), the recommendation system 102 may retrieve data corresponding to another user associated with the third embedding. The data may indicate objects (e.g., items, products, actions, etc.) associated with the other user. As an example, the recommendation system 102 may identify, from the objects, a first object that the user has not purchased or otherwise obtained. The recommendation system 102 may send a recommendation with an indication of the first object (e.g., suggesting that the user purchase or obtain the first object). As another example, the recommendation system 102 may identify, from the objects, a second object that the user has not used or tried. The recommendation system 102 may send a recommendation with an indication of the second object (e.g., suggesting that the user try the first object).

In some embodiments, the recommendation system 102 may identify recommendations using a clustering approach. For example, based on one or more embeddings related to the user (e.g., predicted future versions of the user), the recommendation system 102 may determine a cluster of users. As an example, the recommendation system 102 may input an embedding into a machine learning model to determine which cluster the embedding belongs. As another example, the recommendation system 102 may compute a distance between the embedding and a point in each cluster of a set of clusters. The cluster with the shortest distance may be selected (e.g., as the cluster to the embedding belongs). In some embodiments, each cluster of the cluster set may be associated with a set of products that are recommended to users of the corresponding cluster. The recommendation system 102 may identify one or more products from the set of products associated with the cluster that the user is assigned to (e.g., a cluster that the first embedding belongs to, a cluster that the second embedding belongs to, or from multiple clusters to which at least one embedding associated with the user belong to) and generate one or more recommendations for the products. After generating the recommendations, the recommendation system 102 may send the recommendations to the user device 104.

In some embodiments, the recommendation system 102 may generate one or more recommendations for a user based on a set of future actions predicted via a machine learning model (e.g., the large language model or other machine learning), for example, without comparing embeddings of the user with embeddings of other users. For example, the recommendation system 102 may identify one or more products that may be used if the user were to perform the future actions predicted by the machine learning model. The recommendation system 102 may recommend the products identified to the user. For example, if the machine learning model generates probabilities of future actions that indicate the user has a high probability (e.g., higher than a threshold probability) of opening a particular credit card, the recommendation system 102 may recommend the credit card to the user.

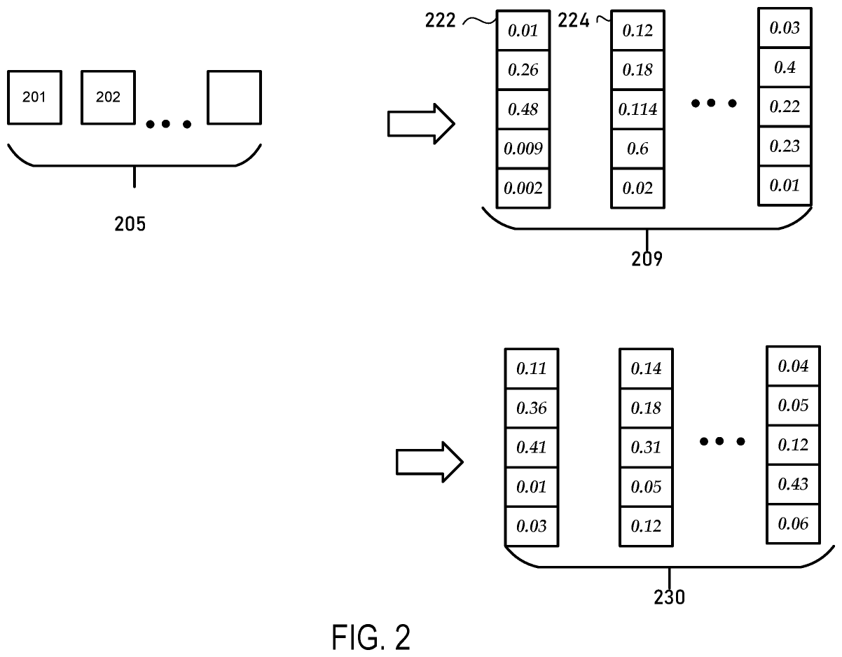

Referring to FIG. 2, example inputs to a machine learning model and example outputs for determining future actions of a user are shown. A user history 205 may be a set of actions (e.g., action 201 and action 202) that a user has previously performed. For example, the actions may be interactions with a software application, actions related to banking, or a variety of other actions. The user history 205 may include each action that the user has taken in the past.

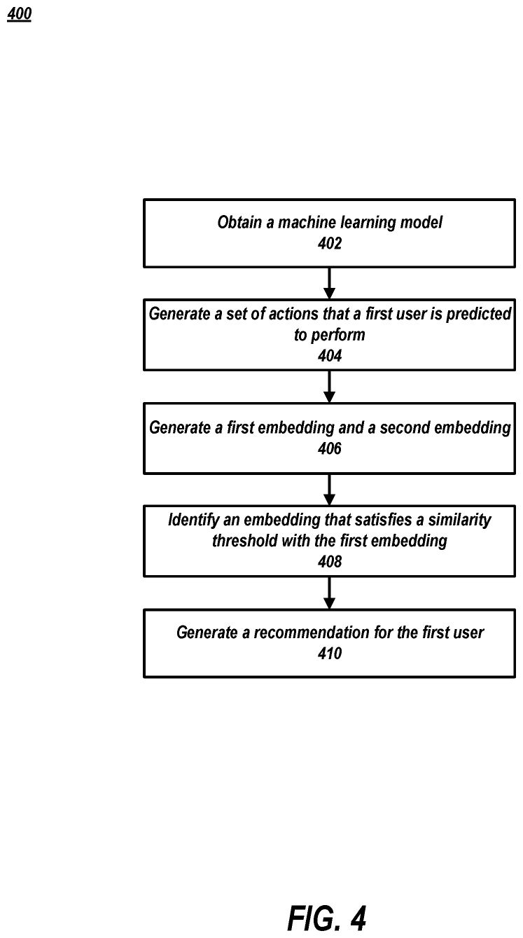

The user history 205 may be input into a machine learning model (e.g., a large language model or any machine learning model described below in connection with FIGS. 3-4). The machine learning model may have been trained to generate probabilities of future events based on a series of actions (e.g., the user history 205).

The machine learning model may use the user history 205 to generate probabilities of future actions 209 and future actions 230 that the user may perform. The system 100 may generate multiple sets of probabilities for the future events 209. For example, probability set 222 may include the probabilities of each possible action that the user may perform at a first-time step, and probability set 224 may include the probabilities of each possible action that the user may perform at a second time step. The computing system may select an action from each probability set as the predicted future action of the user. For example, the computing system may select the action corresponding to the highest probability in probability set 222 as the predicted future action for a first time step and the action corresponding to the highest probability in set 224 as the predicted future action for a second time step.

The probabilities 209 may correspond to a first predicted version of the user. The machine learning model may be used to generate additional predicted versions of the user, for example, by inputting the user history 205 or a portion of the user history 205 multiple times into the machine learning model. For example, the computing system may generate probabilities 230 by inputting the user history 205 into the machine learning model and may determine future predicted actions of the user (e.g., in the same manner as described above for probabilities 209) to create a second predicted version of the user. The different versions of the user may be used to generate embeddings and recommendations, for example, as described in connection with FIGS. 1 and 4.

FIG. 3 shows illustrative components for a system 300 used for training machine learning models or using machine learning models (e.g., determine a recommendation for a user, predict probabilities of future events, or perform any other action described in connection with FIGS. 1-4), in accordance with one or more embodiments. The components shown in system 300 may be used to perform any of the functionality described above in connection with FIG. 1. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1-2 and 4. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., data related to actions, probabilities, or any other data described in connection with FIGS. 1-4).

Additionally, as mobile device 322 and user terminal 324 are shown as a touchscreen smartphone and a personal computer, respectively, these displays also act as user input interfaces. It should be noted that in some embodiments, the devices may have neither user input interfaces nor displays, and may instead receive and display content using another device (e.g., a dedicated display device, such as a computer screen, and/or a dedicated input device, such as a remote control, mouse, voice input, etc.). Additionally, the devices in system 300 may run an application (or another suitable program). The application may cause the processors and/or control circuitry to perform operations related to training machine learning models or using machine learning models (e.g., to determine a recommendation for a user, predict probabilities of future events, or perform any other action described in connection with FIGS. 1-4).

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the embedding system 102 or any other device or component described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, where the first labeled feature input is labeled with a known prediction for the first labeled feature input. The system may then train the first machine learning model to classify the first labeled feature input with the known prediction (e.g., to determine a recommendation for a user, predict probabilities of future events, or perform any other action described in connection with FIGS. 1-4).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may be used to generate probabilities of future actions, recommendations, or perform any other step described in connection with FIGS. 1-4.

System 300 also includes application programming interface (API) layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between front-end and back-end layers. In such cases, API layer 350 may use RESTful APIs (exposition to front-end or even communication between microservices). API layer 350 may use AMQP (e.g., Kafka, RabbitMQ, etc.). API layer 350 may employ incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

FIG. 4 shows a flowchart of the steps involved in using machine learning to generate probabilities of future events to improve recommendations, in accordance with one or more embodiments. Although described as being performed by a computing system, one or more actions described in connection with process 400 of FIG. 4 may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, the computing system may obtain a machine learning model. The machine learning model may be a large language model. A large language model may include a neural network with greater than a threshold number of parameters (e.g., greater than 1 billion parameters, greater than 1 trillion parameters, etc.). The large language model may have been trained using self-supervised learning. Alternatively, the machine learning model may be any model described in connection with FIG. 3. The machine learning model may have been trained to predict an event (e.g., action) or a series of events given a sequence of previous events. For example, the machine learning model may predict the next three actions a user may take (e.g., while the user is interacting with an application) given previous actions the user has taken. The machine learning model may have been trained using sequences of events (e.g., events in the order that they occurred).

At step 404, the computing system may generate a set of actions that a first user is predicted to perform (e.g., network actions or other actions). As an example, an action may include any interaction a user may take with a software application (e.g., a web application, a mobile application, a desktop application, etc.). An action may include interacting (e.g., clicking, tapping, etc.) on a link. An action may include making a deposit in a bank account, opening a new account, applying for a loan, updating user information, taking part in a transaction, making a payment to a loan or other debt, or a variety of other actions including other actions related to banking. The computing system may generate a set of predicted actions, for example, by inputting actions that the first user previously performed into the machine learning model (e.g., the machine learning model obtained at step 402). The previous actions may be input into the machine learning model multiple times or in batches. This may enable the machine learning model to generate different sets of future actions. In some embodiments a first portion of the previous actions may be input into the machine learning model to generate a first subset of future predicted actions, and a second portion of the previous actions may be input into the machine learning model to generate a second subset of future predicted actions. Each subset of future predicted actions may be considered a different version of the first user and may be used to generate recommendations as discussed in more detail below.

In some embodiments, the computing system may generate one or more sets of probabilities of future actions as part of generating the set of actions. To predict a future action, the computing system may generate a set of probabilities that includes one probability for each potential action the first user could take. The computing system may then select the action that has the highest probability as the future action. For example, a first vector in the set of probabilities may include probabilities for every possible action at a first time step, and a second vector in the set of probabilities may include probabilities for every possible action at a second time step.

At step 406, the computing system may generate a first embedding and/or a second embedding. An embedding may be a vector representation of one or more actions (e.g., a set of actions). Two embeddings may be close in distance, for example, if they are generated based on similar sets of actions. The first embedding may be generated by concatenating the previous actions (e.g., all of the previous actions or a portion of the previous actions) with the first subset of future predicted actions and inputting the concatenation into a machine learning model. The machine learning model used to generate the first embedding may be different from the machine learning model used to generate the set of future actions or they may be the same machine learning model. The second embedding may be generated by concatenating the previous actions with the second subset of future predicted actions and inputting the concatenation into a machine learning model (e.g., in the same manner that the first embedding was generated).

In some embodiments, the computing system may generate additional embeddings. For example, the computing system may generate an embedding for each subset of future predicted actions. Each embedding may represent a different version of the first user.

In some embodiments, the computing system may delete or remove versions of the first user that fail to satisfy a quality threshold. For example, a version of the user that includes negative actions may be removed or deleted so that no recommendations are generated based on the negative actions. A negative action may include a user charging off (e.g., cancelling of credit card debt due to the user's inability to pay), a user becoming late in payments, a user undergoing bankruptcy, a user committing fraud, a user being involved in a cybersecurity incident, or a variety of other actions. In one example, the computing system may generate a set of versions of the first user, where each version of the set of versions corresponds to a different set of actions generated via the machine learning model. The computing system may determine, based on the set of versions, a third version that fails to satisfy a quality threshold. Based on the third version failing to satisfy the quality threshold, the computing system may remove the third version from the set of versions. The computing system may generate a recommendation based on the set of versions.

At step 408, the computing system may identify an embedding that satisfies a similarity threshold with the first embedding. For example, the computing system may identify a third embedding that satisfies a similarity threshold with the first embedding or the second embedding. The third embedding may be a representation of another user (e.g., different from the user and the different versions of the user). If the third embedding and the first embedding are similar, the computing system may be able to recommend items (e.g., banking products or other products) that the other user has used to the first user. The similarity threshold may be associated with a distance score related to a distance between the third embedding and the first embedding or a distance score related to a distance between the third embedding and the second embedding. The computing system may determine a distance score (e.g., cosine distance, Euclidean distance, Manhattan distance, etc.) for a pair of embeddings and compare the distance score with a distance threshold (e.g., the similarity threshold) to determine whether two embeddings are similar.

In some embodiments, the third embedding may satisfy a similarity threshold with the first embedding and not the second embedding. The computing system may identify (e.g., by computing distance scores between different embeddings) For example, the computing system may identify a third embedding that satisfies the similarity threshold with the first embedding and a fourth embedding that satisfies the similarity threshold with the second embedding. In this example, the third embedding and fourth embedding may correspond to different users.

At step 410, the computing system may generate a recommendation for the first user. As an example, the computing system may generate the recommendation based on the first embedding, the second embedding, or the third embedding. In one example, the computing system may retrieve (e.g., from the database 106) data corresponding to another user associated with the third embedding. The data may indicate objects (e.g., items, products, actions, etc.) associated with the other user. The computing system may identify from the objects, a first object that the first user has not used or tried. The computing system may send a recommendation with an indication of the first object (e.g., suggesting that the first user try the first object).

In some embodiments, the computing system may identify recommendations using a clustering approach. For example, the computing system may determine, based on the first embedding (e.g., a predicted future first version of the first user) or the second embedding (e.g., a predicted future second version of the first user) a cluster of users. The computing system may input an embedding into a machine learning model to determine which cluster the embedding belongs to. Alternatively, the computing system may compute a distance between the embedding and a point in each cluster. The cluster with the shortest distance may be selected as the cluster the embedding belongs to. Each cluster may be associated with a set of products that are recommended to users of the corresponding cluster. The computing system may identify one or more products from the set of products associated with the cluster that the first user is assigned to (e.g., a cluster that the first embedding belongs to, a cluster that the second embedding belongs to, or from multiple clusters to which at least one embedding associated with the first user belong to) and generate a recommendation for the products.

In some embodiments, the computing system may generate recommendations based on the set of future actions predicted via the machine learning model (e.g., the large language model), for example, without comparing embeddings. For example, the computing system may identify one or more products that may be used if the first user were to perform the future actions generated by the machine learning model. The computing system may recommend the products identified to the first user. For example, if the machine learning model generates probabilities of future actions that indicate the first user has a high probability (e.g., higher than a threshold probability) of opening a particular credit card, the computing system may recommend the credit card to the first user.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: predicting, via a machine learning model (e.g., a large language model or other machine learning model), based on prior actions of a user, a predicted set of actions of the user, the predicted set comprising a first subset of actions corresponding; obtaining a first embedding based on the first subset of actions and a second embedding based on the second subset of actions; and generating one or more recommendations for the user based on the first and second embeddings.
2. The method of the preceding embodiment, wherein the first subset of actions corresponds to a first version of the user, and wherein the second subset of actions corresponds to a second version of the user.
3. The method of any of the preceding embodiments, wherein the machine learning model has been trained (e.g., prior sequential user actions, prior actions of a plurality of users, etc.) to generate probabilities of future user actions.
4. The method of any of the preceding embodiments, wherein the machine learning model comprises a decoder of a transformer, and wherein an action node of the machine learning model comprises a key vector and a query vector used to generate a second action that follows a first action.
5. The method of any of the preceding embodiments, further comprising: generating a set of versions of the user, wherein each version of the set of versions corresponds to a different set of actions predicted via the machine learning model; determining that at least one version of the user fails to satisfy a quality threshold; removing the at least one version of the user from the set of versions based on the at least one version of the user failing to satisfy the quality threshold, wherein generating the one or more recommendations comprises, subsequent to the removal, using the set of versions to generate the one or more recommendations for the user.
6. The method of any of the preceding embodiments, further comprising: obtaining one or more other embeddings that satisfies a similarity threshold with the first or second embedding, wherein generating the one or more recommendations comprises generating the one or more recommendations for the user based on the one or more other embeddings.
7. The method of the preceding embodiment, wherein the first embedding represents the first version of the user, the second embedding represents the second version of the user, and the one or more other embeddings represent one or more other users.
8. The method of any of the preceding embodiments, further comprising: determining a cluster of users based on the first or second embedding, wherein generating the one or more recommendations comprises generating the one or more recommendations for the user based on the cluster of users.
9. The method of the preceding embodiment, further comprising: determining, based on the cluster of users, a set of items obtained by users of the cluster, determining that the user has not obtained a first item of the set of items obtained by the users of the cluster, wherein generating the one or more recommendations comprises generating a recommendation of the first item for the user based on the determination that the user has not obtained the first item of the set of items obtained by the users of the cluster.
10. The method of any of the preceding embodiments, wherein predicting the set of actions of the user comprises, for the first subset of actions (e.g., corresponding to a first version of the user): inputting a first sequential action set, comprising the prior actions of the user, into the machine learning model to predict a first future action of the user; appending the first future action of the user to the first sequential action set such that the first future action follows the prior actions of the user in the first sequential action set; subsequent to the appending of the first future action of the user, inputting the first sequential action set to the machine learning model to predict a second future action of the user, wherein obtaining the first embedding comprises obtaining the first embedding based on the first subset of actions comprising the first and second future actions of the user.
11. The method of the preceding embodiment, wherein obtaining the first embedding comprises generating a first sequential action set in which the second future action follows the first future action based on the prediction of the second future action being derived from the prediction of the first future action.
12. The method of any of the preceding embodiments 10-11, wherein predicting the first future action of the user comprises: obtaining, via the machine learning model, first probabilities of first candidate actions of the user occurring, the first probabilities comprising a first probability of the user performing the first future action; and randomly selecting, from the first candidate actions, the first future action via a random selection proportional to the first probabilities of the first candidate actions.
13. The method of any of the preceding embodiments 10-12, further comprising: wherein predicting the set of actions of the user comprises, for the second subset of actions (e.g., corresponding to a second version of the user): inputting a second sequential action set, comprising the prior actions of the user, into the machine learning model to predict a third future action of the user; appending the third future action of the user to the second sequential action set such that the third future action follows the prior actions of the user in the second sequential action set; subsequent to the appending of the third future action of the user, inputting the second sequential action set to the machine learning model to predict a fourth future action of the user, wherein obtaining the second embedding comprises obtaining the second embedding based on the second subset of actions comprising the third and fourth future actions of the user.
14. A tangible, non-transitory, machine-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.

What is claimed is:

1. A system for facilitating network content recommendations for a user by generating predicted feature embeddings representing different instances of the user, the system comprising:
one or more processors programmed with instructions that, when executed by the one or more processors, cause operations comprising:
generating, via a machine learning model, based on prior sequential network actions of a user, a predicted set of future network actions of the user, the predicted set comprising a first subset of sequential network actions corresponding to a first predicted instance of the user and a second subset of sequential network actions corresponding to a second predicted instance of the user;
generating a first feature embedding based on the first subset of sequential network actions and a second feature embedding based on the second subset of sequential network actions, the first feature embedding representing the first predicted instance of the user, the second feature embedding representing the second predicted instance of the user;
querying a feature embedding space based on the first and second embeddings to obtain a third feature embedding that satisfies a similarity threshold with the first and second embeddings, wherein the similarity threshold comprises a cosine distance that is greater than a threshold cosine distance; and
generating a network content recommendation for the user based on the third feature embedding that satisfies the similar threshold with the first and second embeddings.

2. A method comprising:
obtaining a machine learning model that has been trained on prior sequential user actions to generate probabilities of future user actions;
predicting, via the machine learning model, based on prior sequential actions of a user, a set of future actions of the user, the set of future actions comprising a first subset of actions corresponding to a first instance of the user and a second subset of actions corresponding to a second instance of the user;
obtaining a first feature embedding based on the first subset of actions and a second feature embedding based on the second subset of actions; and
generating one or more recommendations for the user based on the first and second embeddings.

3. The method of claim 2, further comprising:
generating a set of instances of the user, wherein each instance of the set of instances corresponds to a different set of actions predicted via the machine learning model, the set of instances comprising the first instance of the user, the second instance of the user, and a third instance of the user;
determining that the third instance of the user fails to satisfy a quality threshold;
removing the third instance from the set of instances based on the third instance failing to satisfy the quality threshold,
wherein generating the one or more recommendations comprises, subsequent to the removal, using the set of instances to generate the one or more recommendations for the user.

4. The method of claim 3, wherein the quality threshold is related to a probability of a cybersecurity incident associated with the user.

5. The method of claim 2, further comprising:
obtaining one or more other feature embeddings that satisfies a similarity threshold with the first or second embedding,
wherein generating the one or more recommendations comprises generating the one or more recommendations for the user based on the one or more other feature embeddings.

6. The method of claim 5, wherein the first feature embedding represents the first instance of the user, the second feature embedding represents the second instance of the user, and the one or more other feature embeddings represent one or more other users.

7. The method of claim 2, wherein the machine learning model comprises a decoder of a transformer, and wherein an action node of the machine learning model comprises a key vector and a query vector used to generate a second action that follows a first action.

8. The method of claim 2, further comprising:
determining a cluster of users based on the first or second embedding,
wherein generating the one or more recommendations comprises generating the one or more recommendations for the user based on the cluster of users.

9. The method of claim 8, further comprising:
determining, based on the cluster of users, a set of items obtained by users of the cluster,
determining that the user has not obtained a first item of the set of items obtained by the users of the cluster,
wherein generating the one or more recommendations comprises generating a recommendation of the first item for the user based on the determination that the user has not obtained the first item of the set of items obtained by the users of the cluster.

10. The method of claim 2, wherein predicting the set of future actions of the user comprises, for the first subset of actions corresponding to the first instance of the user:
inputting a sequential action set, comprising the prior sequential actions of the user, into the machine learning model to predict a first future action of the user;
appending the first future action of the user to the sequential action set such that the first future action follows the prior sequential actions of the user in the sequential action set;
subsequent to the appending of the first future action of the user, inputting the sequential action set to the machine learning model to predict a second future action of the user,
wherein obtaining the first feature embedding comprises obtaining the first feature embedding based on the first subset of actions comprising the first and second future actions of the user.

11. The method of claim 10, wherein obtaining the first feature embedding comprises generating a first sequential action set in which the second future action follows the first future action based on the prediction of the second future action being derived from the prediction of the first future action.

12. A non-transitory, computer-readable medium comprising instructions that when executed by one or more processors, cause operations comprising:
obtaining a machine learning model that has been trained to generate probabilities of future user actions;
predicting, via the machine learning model, based on prior actions of a user, a set of actions of the user, the predicted set comprising a first subset of actions corresponding to a first version of the user and a second subset of actions corresponding to a second version of the user;
obtaining a first feature embedding based on the first subset of actions and a second feature embedding based on the second subset of actions; and
generating one or more recommendations for the user based on the first and second embeddings.

13. The media of claim 12, the operations further comprising:
generating a set of versions of the user, wherein each version of the set of versions corresponds to a different set of actions predicted via the machine learning model, the set of versions comprising the first version of the user, the second version of the user, and a third version of the user;
determining that the third version of the user fails to satisfy a quality threshold;
removing the third version from the set of versions based on the third version failing to satisfy the quality threshold,
wherein generating the one or more recommendations comprises, subsequent to the removal, using the set of versions to generate the one or more recommendations for the user.

14. The media of claim 12, the operations further comprising:
obtaining one or more other feature embeddings that satisfies a similarity threshold with the first or second embedding,
wherein generating the one or more recommendations comprises generating the one or more recommendations for the user based on the one or more other feature embeddings.

15. The media of claim 14, wherein the first feature embedding represents the first version of the user, the second feature embedding represents the second version of the user, and the one or more other feature embeddings represent one or more other users.

16. The media of claim 12, the operations further comprising:
determining a cluster of users based on the first or second embedding,
wherein generating the one or more recommendations comprises generating the one or more recommendations for the user based on the cluster of users.

17. The media of claim 16, the operations further comprising:
determining, based on the cluster of users, a set of items obtained by users of the cluster,
determining that the user has not obtained a first item of the set of items obtained by the users of the cluster,
wherein generating the one or more recommendations comprises generating a recommendation of the first item for the user based on the determination that the user has not obtained the first item of the set of items obtained by the users of the cluster.

18. The media of claim 12, wherein predicting the set of actions of the user comprises, for the first subset of actions corresponding to the first version of the user:
inputting a sequential action set, comprising the prior sequential actions of the user, into the machine learning model to predict a first future action of the user;
appending the first future action of the user to the sequential action set such that the first future action follows the prior sequential actions of the user in the sequential action set;
subsequent to the appending of the first future action of the user, inputting the sequential action set to the machine learning model to predict a second future action of the user,
wherein obtaining the first feature embedding comprises obtaining the first feature embedding based on the first subset of actions comprising the first and second future actions of the user.

19. The media of claim 18, wherein obtaining the first feature embedding comprises generating a first sequential action set in which the second future action follows the first future action based on the prediction of the second future action being derived from the prediction of the first future action.

20. The media of claim 18, wherein predicting the first future action of the user comprises:
obtaining, via the machine learning model, first probabilities of first candidate actions of the user occurring, the first probabilities comprising a first probability of the user performing the first future action; and
randomly selecting, from the first candidate actions, the first future action via a random selection proportional to the first probabilities of the first candidate actions.
